(19) United States
(12) Patent Application Publication
(10) Pub. No.: US 2018/0343468 A1
(43) Pub. Date: Nov. 29, 2018

(54) Dynamic Encoding Using Remote Encoding Profiles

(71) Applicant: COMCAST CABLE COMMUNICATIONS, LLC, Philadelphia, PA (US)

(72) Inventors: Michael Harrell, Parker, CO (US); Allen Broome, Denver, CO (US); Jason Burgess, Denver, CO (US); Robert Ford, Denver, CO (US)

(21) Appl. No.: 15/606,306

(22) Filed: May 26, 2017

(51) Int. Cl. H04N 19/56; G06F 17/30; H04L 29/06

(52) U.S. Cl. CPC H04N 19/56; H04L 65/605; G06F 17/30997

(57) ABSTRACT

Methods and systems for encoding content are described. An encoder may receive content of a content asset e.g., content media, content distribution, content channel, online channel, show, media, etc.). The encoder may determine an attribute of the content, such as a content type. The encoder may transmit the attribute or other information to a remote device. The remote device may select an encoding profile for encoding of the content. The encoding profile may be selected based on attribute or other information. The encoder may encode the content based on the encoding profile. The encoding profile may be updated based on analysis of the encoded content.

### BACKGROUND

Delivery of content over a network typically includes encoding of content by encoders. For real-time linear content channels, encoders have a limited time to determine optimal encoding settings, resulting in lower quality encoding. Thus, there is a need for methods and systems to overcome such a challenge.

### SUMMARY

It is to be understood that both the following general description and the following detailed description are examples and explanatory only and are not restrictive. Methods and systems for encoding content are disclosed. An example system may comprise one or more encoders configured to store encoding profiles in a remote server. The one or more encoders may optimize encoding profiles that generate higher quality encoding. For example, an encoding profile may be selected by the remote server based on a variety of attributes of content, such as content type, content source, and content asset (e.g., content media, content distribution, content channel, online channel, show, media, etc.). One or more of the attributes may be determined based on electronic program guide data. For example, an electronic program guide may be queried based on channel, program, and/or time to determine metadata (e.g., genre, content type) indicating the one or more attributes. The remote server may select encoding profiles that are relevant to current, real-time content (e.g., received as linear content channel, received via a content asset). For example, a program (e.g., content item, program associated with a content asset) and/or content source may be correlated to a specific encoding profile. The encoder may receive the encoding profile from the remote device and use the encoding profile to encode the related content. The results of the encoding may be analyzed to determine encoding quality. The encoding profile may be used as a baseline for generating and/or selecting a new encoding profile. If the new encoding profile generates higher quality content, then the new encoding profile may be stored at the remote server for subsequent use in encoding content, such as the same program (e.g., content of from the same content asset), source, and/or content of the same type. Additionally, large data sets may of encoding profiles, encoding quality metrics, content types, and/or other data may be analyzed to determine trends, which may be used to determine more optimal encoding profiles.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, show embodiments and together with the description, serve to explain the principles of the methods and systems:

FIG. 1 is a block diagram of an example content distribution and access system;

FIG. 2 is a block diagram of an example encoding system;

FIG. 3 is a block diagram of another example encoding system;

FIG. 4 is a flow chart of an example method for encoding content;

FIG. 5 is a flow chart of another example method for encoding content;

FIG. 6 is a flow chart of another example method for encoding content; and

FIG. 7 is a block diagram of an example computing system in which the present methods and systems may operate.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowcharts of methods, systems, apparatuses and computer program products. It will be understood that each block of the block diagrams and flowcharts, and combinations of blocks in the block diagrams and flowcharts, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowcharts support combinations of means for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

In various instances, this detailed description may refer to content assets (which may also be referred to as “content,” “content data,” “content information,” “multimedia asset data file,” or simply “data” or “information”). In some instances, content assets may comprise any information or data that may be licensed to one or more individuals (or other entities, such as business or group). In various embodiments, content may include electronic representations of video, audio, text and/or graphics, which may include but is not limited to electronic representations of videos, movies, or other multimedia, which may include but is not limited to data files adhering to MPEG2, MPEG, MPEG4 UHD, MDR, 4k, Adobe® Flash® Video (FLV) format or sonic other video file format whether such format is presently known or developed in the future. In various embodiments, the content assets described herein may include electronic representations of music, spoken words, or other audio, which may include but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and. Secondary Audio Programs (SAP), Sound Document (.ASND) format or some other format configured to store electronic audio whether such format is presently known or developed in the future. In some cases, content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content assets may include content media, content distributions, content channels (e.g., television channels), online channels, media, etc. . . . Additionally, content assets may include any combination of the above-described examples.

In various instances, is detailed disclosure may refer to consuming content (e.g., content assets) or to the consumption of content, which may also be referred to as “accessing” content, “providing” content, “viewing” content, “listening” to content, “rendering” content, or “playing” content, among other things. In some cases, the particular term utilized may be dependent on the context in which it is used. For example, consuming video may also be referred to as viewing or playing the video. In another example, consuming audio may also be referred to as listening to or playing the audio.

Note that in various instances this detailed disclosure may refer to a given entity performing some action. It should be understood that this language may in some cases mean that a system (e.g., a computer) owned and/or controlled by the given entity is actually performing the action.

Methods and systems for encoding content are described by the present disclosure. The present disclosure describes a dynamic and adaptive encoding system. The encoding system may encode content, such as video and audio content. Specific programs, sources, and/or content assets (e.g., content media, content distributions, content channels, television channel, online channel, show, media, etc.) may be associated with corresponding encoding profiles. For example, a sports channel (e.g., a content asset associated with sports) may be associated with an encoding profile optimized to encode fast moving scenes. As another example, a news asset (e.g., content asset, content channel associated with news, news distribution, etc.) may be associated with an encoding profile optimized to encode relatively little movement in a scene. Encoding profiles may be associated with and selected based on content type. Electronic program guide data (e.g., metadata) may be used to determine a content type (e.g., genre) associated with a program. For example, and encoder, encoder controller, or other devices may query an electronic program guide server to determine metadata associated with a particular asset, channel, program, time, and/or the like. For example, the metadata may comprise a genre, which may he indicative of content type.

A cloud based (e.g., remotely located) encoding manager may manage encoding profiles for a plurality of encoders. Specific encoding profiles may be matched to corresponding content based on type of content or other attributes. A history of encoding profiles used for various types of content, programs, and/or the like may be stored and leveraged to match content received on live/linear content transmissions to appropriate encoding profiles. Encoding profiles may be refined after each use by analyzing encoding quality of the content encoded using the encoding profile. Encoding configuration parameters in the encoding profiles may be modified (e.g., reverted to prior values, changed to new values) depending on the encoding quality analysis to optimize the encoding quality of an encoding profile.

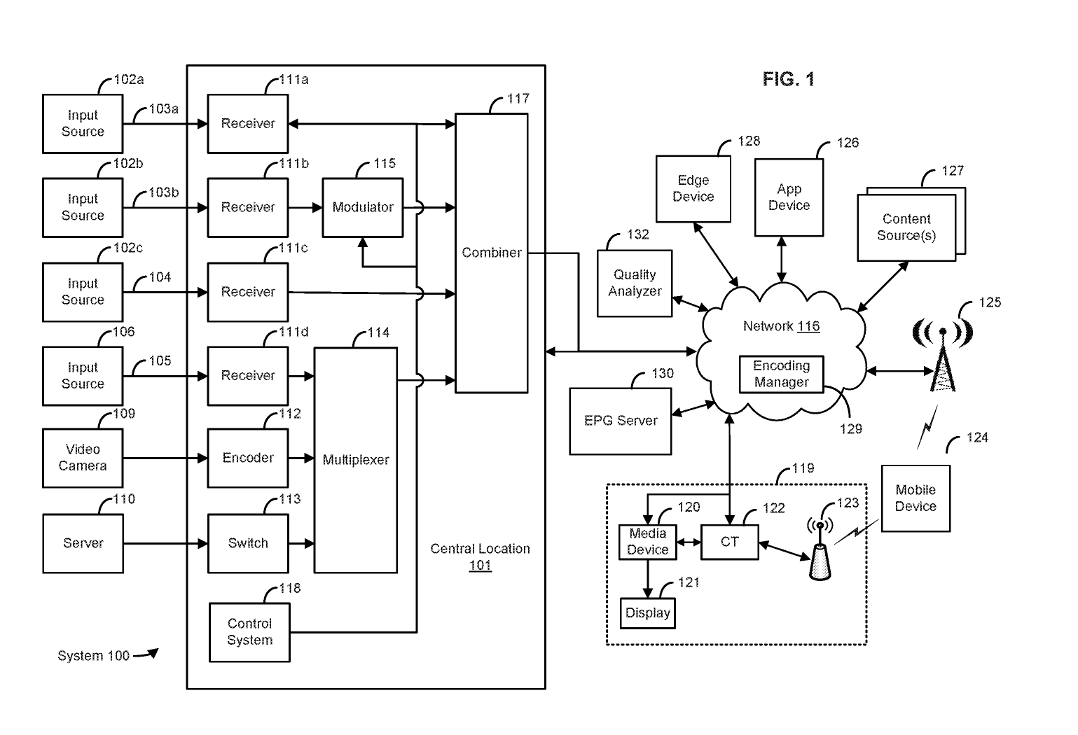

FIG. 1 is a block diagram of an example system in which the present methods and systems may operate. Those skilled in the art will appreciate that present methods may be used in systems that employ both digital and analog equipment. One skilled in the art will appreciate that provided herein is a functional description and that the respective functions may be performed by software, hardware, or a combination of software and hardware.

A system 100 may comprise a central location 101 (e.g., a headend), which may receive content (e.g., data, input programming, and the like) and/or content assets (e.g., content media, content distributions, content channels, online channels, shows, media, etc.) from multiple sources (e.g., content sources). The central location 101 may combine the content from the various sources and may distribute the content to user (e.g., subscriber) locations (e.g., user location 119) via a network 116 (e.g., a content distribution and access system).

The central location 101 may receive content from a variety of sources 102a, 102b, 102c. The content may be transmitted from the source to the central location 101 via a variety of transmission paths, including wireless (e.g. satellite paths 103a, 103b) and a terrestrial path 104. The central location 101 may also receive content from a direct feed source 106 via a direct line 105. Other input sources may comprise capture devices such as a video camera 109 or a server 110. The signals provided by the content sources may include a single content asset (e.g., content media content distribution, content channel, online channel, show, media, etc.) or a multiplex that includes several content assets (e.g., content media, television channels, online channels, media, etc.).

The central location 101 may comprise one or a plurality of receivers 111a, 111b, 111c, 111d that are each associated with an input source. For example, MPEG encoders such as an encoder 112, are included for encoding local content or a video camera 109 feed.

The encoder 112 may be configured to encode one or more content streams. For example, the encoder 112 may comprise one or more encoders configured to receive content and encode the content into one or more content streams. The encoder 112 may encode one or more source content streams into a plurality of content streams. The plurality of content streams may be encoded at different bit rates. Additionally, the encoder 112 may encode the content into a compressed and/or encrypted format. For example, the encoding unit 308 may encode the content into an MPEG stream.

The encoder 112 may be configured to perform intra-frame and inter-frame encoding (e.g., compression). For example, intra-frame encoding may comprise encoding a frame of content, such as a video frame, by reference to the frame itself. Inter-frame encoding may comprise compressing a frame of content, such as video frame, by reference to one or more other frames. As an example, an intra-coded frame (“I-frame”) may comprise a frame of content that is encoded without reference to other frames. A predictive coded frame (“P-frame) may comprise a frame of content encoded with reference to another frame, such as an I-frame. A bi-directionally predictive coded (“B-frame”) frame may comprise a frame of content encoded with reference to multiple frames. For example, the encoder 112 may be configured to encode a content stream into a plurality of I-frames, P-frames, and B-frames. The plurality of I-frames, P-frames, and B-frames may be organized into groups, each group known as a group of frames and/or group of pictures (GOP).

Encoding a frame of content with reference to another frame may comprise encoding one or more motion vectors configured to correlate a portion of the encoded frame to a portion of a referenced frame. The motion vectors may indicate a difference in location between one or more pixels of the encoded frame and one or more identical or similar pixels in the reference frame. A motion vector may comprise, for example, a direction and a distance between two points in a coordinate system. As another example, a motion vector may comprise a coordinate in a reference frame and a coordinate in the encoded frame. By way of explanation, an I-frame may be encoded by encoding all the pixels in a frame. P-frames and/or B-frames may be encoded without encoding all of the pixels in a frame. Instead, motion vectors may be encoded that associate (e.g., correlate) portions (e.g., pixels) of a reference frame and the location thereof to portions of an encoded frame and the location thereof. If a portion of a reference frame identified by a motion vector is not identical to the associated portion of the frame being encoded, then the encoder 112 may identify differences between the portion of the reference frame referenced by the motion vectors and the portion of the frame being encoded. These differences are known as prediction errors.

The encoder 112 may be configured to perform one or more transformation algorithms on the content. For example, the encoding unit 308 may be configured to perform a discrete cosine transform. A transformation algorithm may comprise expressing the content as a summation of functions (e.g., a summation of cosine functions). The functions may be related according to a formula. For example, each function may be raised to exponents, multiplied by coefficients, and/or provided arguments based on a summation formula. At least a portion of the content may be transformed according to a transformation algorithm. The coefficients of the functions resulting from the transformation algorithm may be encoded and transmitted as encoded content. For example, the encoder 112 may be configured to encode only a portion of the coefficients resulting from the transformation algorithm.

The encoder 112 may be configured to quantize the content and/or encoded data indicating the content (e.g., coefficients resulting from a transformation algorithm). Quantization may comprise converting content and/or encoded data into a smaller set of content and/or encoded data. For example, the coefficients may comprise an integer (e.g., 299792458) and/or a non-integer (e.g., 1.618033) real number. The encoder 112 may be configured to quantize a coefficient by truncating, rounding, or otherwise reducing the number of digits in a number. For example, the example coefficient 1.618033 may be quantized to 1.618. The amount of quantization may be based on a quantization step size. A smaller quantization step size results in the loss of less data than a larger quantization step size. For example, a larger quantization step size may result in a quantized coefficient of 1.61 and a smaller quantization step size may result in a quantized coefficient of 1.61803.

The methods and systems may utilize digital audio/video compression such as MPEG, or any other type of compression. For example, the encoder 112 may be configured to encode the content using MPEG or other compression. The Moving Pictures Experts Group (MPEG) was established by the International Standards Organization (ISO) for the purpose of creating standards for digital audio/video compression. The MPEG experts created the MPEG-1 and MPEG-2 standards, with the MPEG-1 standard being a subset of the MPEG-2 standard. The combined MPEG-1, MPEG-2, and MPEG-4 standards are hereinafter referred to as MPEG. In an MPEG encoded transmission, content and other data are transmitted in packets, which collectively make up a transport stream. Additional information regarding transport stream packets, the composition of the transport stream, types of MPEG tables, and other aspects of the MPEG standards are described below. The present methods and systems may employ transmission of MPEG packets. However, the present methods and systems are not so limited, and may be implemented using other types of transmission and data.

The output of a single MPEG audio and/or video coder is called a transport stream comprised of one or more elementary streams. An elementary stream is an endless near real-time signal. For convenience, the elementary stream may be broken into data blocks of manageable size, forming a packetized elementary stream (PES). These data blocks need header information to identify the start of the packets and must include time stamps because packetizing disrupts the time axis. For transmission and digital broadcasting, for example, several programs and their associated PESs may be multiplexed into a multi program transport stream. A multi program transport stream has a program clock reference (PCR) mechanism that allows transmission of multiple clocks, one of which is selected and regenerated at the decoder.

A multi program transport stream is more than just a multiplex of audio and video PESs. In addition to the compressed audio, video and data, a transport stream includes metadata describing the bit stream. This includes the program association table (PAT) that lists every program in the multi program transport stream. Each entry in the PAT points to a program map table (PMT) that lists the elementary streams making up each program. Some programs will be unencrypted, but some programs may be subject to conditional access (encryption) and this information is also carried in the metadata. The transport stream may be comprised of fixed-size data packets, for example, each comprising 188 bytes. Each packet may carry a program identifier code (PID). Packets in the same elementary stream may all have the same PID, so that the decoder (or a demultiplexer) may select the elementary stream(s) it wants and reject the remainder. Packet continuity counts ensure that every packet that is needed to decode a stream is received. A synchronization system may be used so that decoders may correctly identify the beginning of each packet and deserialize the bit stream into words.

A content asset (e.g., content media, content distribution, content channel, online channel, show, media, etc.) may be a group of one or more PIDs that are related to each other. For instance, a multi program transport stream used in digital television might comprise three programs, to represent three television channels. Suppose each channel consists of one video stream, one or two audio streams, and any necessary metadata. A receiver wishing to tune to a particular “channel” merely has to decode the payload of the PIDs associated with its program. It may discard the contents of all other PIDs.

The multi program transport stream may carry many different programs and each may use a different compression factor and a bit rate that may change dynamically even though the overall bit rate stays constant. This behavior is called statistical multiplexing and it allows a program that is handling difficult material to borrow bandwidth from a program handling easy material. Each video PES may have a different number of audio and data. PESs associated with it. Despite this flexibility, a decoder needs to be able to change from one program to the next and correctly select the appropriate audio and data channels. Some of the programs may be protected so that they may only be viewed by those who have paid a subscription or fee. The transport stream may comprise Conditional Access (CA) information to administer this protection. The transport stream may comprise Program Specific Information (PSI) to handle these tasks.

As described further herein, the encoder 112 may process incoming content (e.g., video, audio, text) by using one or more encoding profiles. The encoding profiles may instruct the encoder 112 to applying filtering such as motion compensated temporal filtering, de-blocking filtering, sharpening, de-noising, and/or a variety of other filters. These filters may be used to better handle noise, macro-blocking caused from over compression from the source, ringing from poor edge detection, and other encoding quality problem. The encoder 112 may be communicatively coupled (e.g., via network 116) to other devices in the system 100, such as the electronic program guide server 130, the encoding manager 129, and the quality analyzer 132. As describer further herein, the encoder 112 may send and receive data via the network 116 to the other devices in the system 100.

A switch 113 may provide access to the server 110, which may be a Pay-Per-View server, a data server, an internet router, a network system, a phone system, and the like. Some signals may require additional processing, such as signal multiplexing, prior to being modulated. Such multiplexing may be performed by a multiplexer (mux) 114.

The central location 101 may comprise a modulator 115 (e.g., or a plurality of modulators) for interfacing to a network 116. The modulator 115 may convert the received content into a modulated output signal suitable for transmission over a network 116. The output signals from the modulator 115 may be combined, using equipment such as a combiner 117, for input into the network 116. The network 116 may comprise a content delivery network, a content access network, and/or the like. For example, the network 116 may be configured to transmit content from a variety of sources using a variety of network paths, protocols, devices, and/or the like. The content delivery network and/or content access network may be managed deployed, serviced) by a content provider, a service provider, and/or the like.

A control system 118 may permit a system operator to control and monitor the functions and performance of the system 100. The control system 118 may interface, monitor, and/or control a variety of functions, including, but not limited to, the channel lineup for the television system, billing for each user, conditional access for content distributed to users, and the like. The control system 118 may send input to the modulator 115 for setting operating parameters, such as system specific MPEG table packet organization or conditional access information. The control system 118 may be located at the central location 101 or at a remote location.

The network 116 may distribute signals from the central location 101 to user locations, such as a user location 119. The network 116 may comprise an optical fiber network, a coaxial cable network, a hybrid fiber-coaxial network, a wireless network, a satellite system, a direct broadcast system, an Ethernet network, a high-definition multimedia interface network, universal serial bus network, or any combination thereof.

A multitude of users may be connected to the network 116 at one or more of the user locations. At the user location 119, a media device 120 may demodulate and/or decode, if needed, the signals for display on a display device 121, such as on a television set (TV) or a computer monitor. For example, the media device 120 may comprise a demodulator, decoder, frequency tuner, and/or the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may comprise a set-top box, a digital streaming device, a gaming device, a media storage device, a digital recording device, a combination thereof, and/or the like. The media device 120 may comprise one or more applications, such as content viewers, social media applications, news applications, gaming applications, content stores, electronic program guides, and/or the like. Those skilled in the art will appreciate that the signal may be demodulated and/or decoded in a variety of equipment, including the communication terminal 122, a computer, a TV, a monitor, or satellite dish.

The communication terminal 122 may be located at the user location 119. The communication terminal 122 may be configured to communicate with the network 116. The communication terminal 122 may comprise a modem e.g., cable modem), a router, a gateway, a switch, a network terminal (e.g., optical network unit), and/or the like. The communication terminal 122 may be configured for communication with the network 116 via a variety of protocols, such as internet protocol, transmission control protocol, file transfer protocol, session initiation protocol, voice over internet protocol, and/or the like. For example, for a cable network, the communication terminal 122 may be configured to provide network access via a variety of communication protocols and standards, such as Data Over Cable Service Interface Specification.

The user location 119 may comprise a first access point 123, such as a wireless access point. The first access point 123 may be configured to provide one or more wireless networks in at least a portion of the user location 119. The first access point 123 may be configured to provide access to the network 116 to devices configured with a compatible wireless radio, such as a mobile device 124, the media device 120, the display device 121, or other computing devices (e.g., laptops, sensor devices, security devices). For example, the first access point 123 may provide a user managed network (e.g., local area network), a service provider managed network (e.g., public network for users of the service provider), and/or the like. It should be noted that in some configurations, some or all of the first access point 123, the communication terminal 122, the media device 120, and the display device 121 may be implemented as a single device.

Additionally, the user location 119 may not be fixed. By way of example, a user may receive content from the network 116 on the mobile device 124. The mobile device 124 may comprise a laptop computer, a tablet device, a computer station, a personal data assistant (PDA), a smart device (e.g., smart phone, smart apparel, smart watch, smart glasses), GPS, a vehicle entertainment system, a portable media player, a combination thereof, and/or the like. The mobile device 124 may communicate with a variety of access points (e.g., at different times and locations or simultaneously if within range of multiple access points). For example, the mobile device 124 may communicate with a second access point 125. The second access point 125 may be a cell tower, a wireless hotspot, another mobile device, and/or other remote access point. The second access point 125 may be within range of the user location 119 or remote from the user location 119. For example, the second access point 125 may be located along a travel route, within a business or residence, or other useful locations (e.g., travel stop, city center, park).

The system 100 may comprise an application device 126. The application device 126 may be a computing device, such as a server. The application device 126 may provide services related to applications. For example, the application device 126 may comprise an application store. The application store may be configured to allow users to purchase, download, install, upgrade, and/or otherwise manage applications. For example, the application device 126 may be configured to allow users to download applications to a device, such as the mobile device 124, communication terminal 122, the media device 120, the display device 121, and/or the like. The application device 126 may run one or more application services to transmit data, handle requests, and/or otherwise facilitate operation of applications for the user.

The system 100 may comprise one or more content source(s) 127 (e.g., in addition to sources 102a, 102b, 102c, and 106 described elsewhere herein). The content source(s) 127 may be configured to transmit content (e.g., video, audio, games, applications, data) to the user. The content source(s) 127 may be configured to transmit streaming media, such as on-demand content (e.g., video on-demand), content recordings, and/or the like. For example, the content source(s) 127 may be managed by third party content providers, service providers, online content providers, over-the-top content providers, and/or the like. The content may be provided via a subscription, by individual item purchase or rental, and/or the like. The content source(s) 127 may be configured to transmit the content via a packet switched network path, such as via an internet protocol (IP) based connection. The content may be accessed by users via applications, such as mobile applications, television applications, set-top box applications, gaming device applications, and/or the like. An example application may be a custom application (e.g., by content provider, for a specific device), a general content browser (e.g., web browser), an electronic program guide, and/or the like.

The system 100 may comprise an edge device 128. The edge device 128 may be configured to provide content, services, and/or the like to the user location 119. For example, the edge device 128 may be one of a plurality of edge devices distributed across the network 116. The edge device 128 may be located in a region proximate to the user location 119. A request for content from the user may be directed to the edge device 128 (e.g., due to the location of the edge device 128 and/or network conditions). The edge device 128 may be configured to package content for delivery to the user (e.g., in a specific format requested by a user device), transmit the user a manifest file (e.g., or other index file describing segments of the content), transmit streaming content (e.g., unicast, multicast), transmit a file transfer, and/or the like. The edge device 128 may cache or otherwise store content (e.g., frequently requested content) to enable faster delivery of content to users.

The network 116 may comprise an encoding manager 129 (e.g., encoding controller). In some implementations, the encoding manager 129 may be located at the central location 101. The encoding manager 129 may be configured to store and/or access a plurality of encoding profiles, encoding quality metrics associated with the encoding profiles, and/or the like. The encoding manager 129 may determine (e.g., select, suggest) encoding profiles for the encoder 112. For example, different encoding profiles may be selected and transmitted to the encoder 112 based one or more attributes of content to encode. The encoding manager 129 may determine a program (e.g., show, episode, movie, newscast, sportscast) within the content. The encoding manager 129 may determine an attribute (e.g., type, genre, identifier) of the program. The attribute may be associated with an encoding profile. Accordingly, the relevant encoding profile for the program may be selected and transmitted to the encoder 112 for encoding the program. The encoding profile for the program may be selected before the content is schedule to be transmitted. The encoding manager 129 may also replace (e.g., after encoding and/or transmission of the content has begun) the selected encoding profile with a different and/or modified encoding profile as explained further herein.

In some scenarios, the program and/or attribute may be determined by requesting information from an electronic program guide (EPG) server 130. The EPG server 130 may be configured to store guide information related to content provided via one or more content assets (e.g., content media, content distribution, content channel, online channel, show, media, etc.). For example, the content may comprise a sequence of programs (e.g., content assets) transmitted from one or more sources (e.g., content sources). The guide information may comprise a schedule of the sequence of programs. The guide information may comprise metadata related to content. For example, the guide information may comprise a type of content (e.g., genre, sports, news, show, episode, movie), people (e.g., directors, producers, actors, actresses, team, contestant, player) associated with content, a title of content, a resolution of content, and/or the like. The guide information may be specific to a content item (e.g., a particular episode of a show, a series of episodes, a movie, a genre), a content asset (e.g., content channel), a source (e.g., one content asset/channel can be served by geographically disparate sources), a person or entity (e.g., broadcaster, team, company, film company), and/or the like. The EPG server 130 may be configured to transmit portions of the guide information in response to queries from a variety of devices, such as the encoding manager 129 and the media device 120.

As an example, the encoding manager 129 may query the EPG server 130 to identify an upcoming program to be encoded by the encoder 112 and/or a program type of the program. The query to the EPG server 130 may be transmitted with an identifier of an encoder, a content source, a program, and/or a content asset (e.g., content media, content distribution, content channel, online channel, show, media, etc.). The EPG server 130 may use the identifier or other information to find the information requested in the query.

The network 116 may comprise a quality analyzer 132. The quality analyzer 132 may be configured to analyze encoded content received from the encoder 112. The quality analyzer 132 may determine one or more encoding quality metrics based on the analysis of the content. The quality analyzer 132 may transmit the one or more encoding quality metrics to the encoding manager 129.

An example encoding quality metric may be specific to a program associated with a content item (e.g., a program), a content asset (e.g., content media, content distribution, content channel, online channel, show, media, etc.), a source (e.g., content source), and/or the like. The encoding quality metric may be specific to an encoding profile used for encoding the content analyzed. The encoding quality metric may comprise an unreferenced encoding quality metric (e.g., baseline quality metric, overall quality metric), a referenced encoding quality metric (e.g., comparison of input to output), a combination thereof, and/or the like.

The quality analyzer 132 may perform an unreferenced analysis of the content to determine the unreferenced encoding quality metric. For example, a mean opinion score (MOS) may be determined. The MOS may comprise a score from 0 to 5.0 (e.g., with 5.0 being the highest quality, a score of about 4.0 and above may be considered a good score). Scores (e.g., ratings) may be determined for noise, blockiness, blurriness, jerkiness, a combination thereof, and/or the like based on analysis of the content. In some implementations, the MOS may be based on the scores of the blockiness, the blurriness, the jerkiness, a combination thereof, and/or the like. The quality analyzer 132 may perform a referenced quality analysis to determine the referenced encoding quality metric. The referenced quality analysis may indicate how closely the output of the encoder 112 matches the incoming content (e.g., from source 102 or content source 127). The referenced base analysis may comprise a structural similarity (SSIM) score. The SSIM score may indicate how well the encoder is performing on a video quality basis. The referenced base analysis score may be a percentage. For example, the SSIM may be on a scale from 0 to 100 percent (e.g., percent similarity, where about 85 to 100 indicates excellent video quality). The referenced quality analysis may be a comparison of the input content to output content of the encoder 112. The referenced quality analysis may be a comparison of a quality metric (e.g., MOS) of the input content to a quality metric of the output content.

The encoding quality metric may be based on analysis of a portion of the content, such as a single or multiple frames. For example, a first frame of the input may be compared to a corresponding second frame of the output. Pixels of the first frame may be compared to corresponding pixels of the second frame. The encoding quality metric may be based on analysis of a segment (e.g., a group of pictures, a scene). The segment may be a fragment, a block of frames within a specified time threshold (e.g., the last X number of seconds, where X is any appropriate number, such as 1, 2, 5, 10, etc.). The encoding quality metric may be based on analysis of a plurality of frames (e.g., all of the frames of the content).

The methods and systems disclosed may be located within the encoding manager 129, the quality analyzer 132, the EPG server 130, and/or the encoder 112. For example, the encoding manager 129 may use encoding quality metrics and guide information to optimize encoding profiles specific to individual programs (e.g., content items) associated with content assets (e.g., content media, content distribution, content channel, online channel, show, media, etc.). An encoding profile may be modified or replaced after encoding and/or transmission (e.g., after the scheduled air start time) has begun (e.g., and before the encoding and/or transmission is finished). For example, the encoder 112 may encode a first portion of content (e.g., live content, a show, an episode, a movie, a newscast) with a first encoding profile. The encoder 112 may encode a second portion (e.g., subsequent to the first portion) using a replacement encoding profile.

The present methods and systems enable encoding of live content streams to gradually be improved (e.g., during encoding/transmission of the content or through subsequent encoding of the same or similar content) as encoding quality metrics are used to refine encoding profiles for content. A typical encoder of linear or live content streams has limited resources for optimizing encoding profiles due to the time constraints of encoding content in a timely manner. The present methods and systems may be implemented primarily by the encoder 112, primarily by the encoding manager 129 (e.g., a cloud based system) for optimizing encoding profiles, by both the encoder 112 and the encoding manager 129, and/or any other device. For example, the encoder 112 may receive the encoding quality metrics and the content attributes and modify encoder configuration settings (e.g., use a different encoding profile or update a portion of an encoding profile). As another example, the encoding manager 129 may receive the encoding quality metrics and the content attributes and select (e.g., or generate) new encoding profiles (e.g., modified from prior encoding profiles). Overtime, the encoding profiles (e.g., for a particular program, content asset (channel), and/or source) may be refined by successive use, analysis of the results of encoding, and refinement based on the analysis.

The encoding manager 129 may perform analysis of large data sets (e.g., commonly referred to as “big data”) to optimize (e.g., select and/or generate optimal) encoding profiles. For example, data may be collected from a plurality of encoders, for a plurality of encoding profiles, for a plurality of content (e.g., content media, content distribution, content channel, online channel, show, media, etc.), and/or for a plurality of content characteristics. The data may be analyzed (e.g., using big data analysis) to determine trends, patterns, associations, and/or the like. As the encoding quality metrics are collected and changes to encoding profiles tracked, trends may be determined for identifying optimal encoding configuration parameters of encoding profiles. For example, a program (e.g., show) that airs on a specific channel on a regular basis (e.g., daily/weekly bases, such as professional football, every Sunday, on a broadcast network in a particular city), may have associated data indicating characteristics of the program, broadcast source (e.g., a broadcaster, a geographic region, a source feed), encoding profiles used, configuration parameters of the encoding profiles, changes made to the configuration parameters and/or encoding profiles, encoding quality metrics before and/or after the changes in configuration, differences between the before and after encoding quality metrics, and/or the like.

The encoding profiles may be optimized by basic comparison of encoding quality metrics before a change (e.g., encoding profile and/or configuration parameter change) to encoding quality metrics after a change. If the change results in lower encoding quality (e.g., from higher to lower encoding quality metric), then the change may be reversed and/or further refined. For example, if adding a filter to an encoding profile results in lower encoding quality, the filter may be removed or a setting (e.g., low, medium, high) of the filter may be modified (e.g., from low to medium, from high to medium, from low to high, from high to low, from medium to high, from medium to low).

The encoding quality metrics may be optimized by more complex analysis of the data to determine trends and patterns. The trends may be specific to genres, channels, geographic regions, viewership, scene types (e.g., action, talking heads), network conditions, production style (e.g., types of camera shots, lighting, story-telling method), person (e.g., actor, director, producer, cinematographer), a combination thereof, and/or any other feature. The trends may associate encoding quality metrics, encoding profile, encoding configuration parameters, and/or the like with features of the data. One or more of the trends may be used to determine the best encoding profile and/or encoding configuration parameters for a program on a particular channel. As subsequent similar programming airs, the optimal encoding profile may be applied at the start of the program for that channel. Encoding quality metrics and encoder configuration changes may be tracked for every program on every channel. As the features of the program change (e.g., more noise due to night scenes, less fast mvement and more talking) over time (e.g., during airing of the program, over multiple airings of episodes of a program), the encoding profile may be replaced and/or modified to match the changes in the program. As a further example, trends may predict that a particular program may be optimally encoded using several different encoding profiles throughout a particular episode, throughout a season, and/or the like. Changes in demographics, weather, political climate, economic conditions, technology, and/or the like may be correlated with and/or used to predict trends (e.g., or changes) in content. The expected trends in content may then be used to selected appropriate encoding profiles, encoding configuration parameters, and/or the like.

As an example, the content for encoding may be Sunday night football on NBC in Denver. Over a time period (e.g., 8 weeks), encoding quality metrics, inputs, compression algorithms, and/or other data may be stored. If there is a night game or the source is acquired differently, the content may have more noise compared to prior games. Comparison of encoding quality metrics of the night game to encoding quality metrics of the prior games may indicate that the encoding quality has decreased. A different (e.g., or modified) encoding profile may be selected (e.g., during broadcast) and applied to filter out the noise. At the next game, the encoding manager 129 may analyze a trend (e.g., noise was generally not an issue because of day games) over the 8 weeks and determine to use the earlier profile instead of the one used for noise. Then, the encoding manager 129 may analyze encoding quality metrics of the next game to determine if noise occurred. If there was no noise, then the earlier encoding profile would continue to be used. If there was noise, the encoding profile used for the night game may be selected (e.g., perhaps gradually adapted). In another scenario, the encoding manager 129 may determine to use the night game encoding profile instead of the earlier encoding profile due to other trends, such as later games, changes in seasons resulting in earlier nightfall, and/or the like.

Additionally, the encoding manager 129 may analyze encoding quality metrics as follows. An encoding quality metric may be compared to a threshold. For example, if the SSIM score is below a threshold (e.g., 85%, 70%), then a different encoding profile may be selected. The encoding manager 129 may analyze the MOS score (e.g., or scores that make up the MOS score) to determine specific problems with the encoded content. For example, a low score (e.g., below 4.0, below 3.0) may indicate that a filter caused artifacting of the encoded content. The filter may be removed or set to a lower setting (e.g., low, medium). Additionally, the MOS score may indicate other issues, such as noise. A filter may be selected to remove noise and added to the encoding profile. Further analysis and refinement of the encoding profiles may occur as filters and/or filter parameters are associated with various encoding quality metrics. For example, trends may be determined related to the use of specific filters and/or filter parameters and the resulting encoding quality metrics. These trends may be specific to content type (e.g., genre content asset (e.g., content media, content distribution, content channel, online channel, show, media, etc.), source (e.g. content source, content distributor, television station, etc.), and/or other stored events and/or content features.

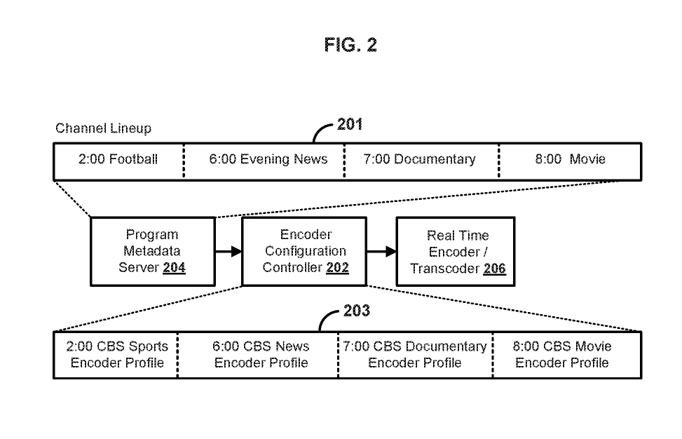

FIG. 2 is a diagram of an example data flow of a system for encoding and delivering content. Video compression algorithms are currently generic per channel with minimal feedback to determine impact to video quality based on compression algorithm. Content on a channel may change based on content type, how the content was acquired, and/or the features, resulting in variations of noise and pre-compression artifacts. Generic compression algorithms may be created to address specific types of artifacting. Current configurations may be static with some dynamic filtering that occurs in the compression engine. Dynamic filtering may be very limited in functionality and does not include all configuration parameters including bit rate nor incorporate feedback from a video quality system.

Example metadata for a content stream 201 exemplifies that a single content stream may have a variety of content assets (e.g., programs of different content types). Dashed lines indicate a logical separation between programs (e.g., content assets) in the content stream. Encoding profiles 203 may be selected based on associated content types to improve encoding quality for a particular channel. Dashed lines indicate logical separation between encoding profiles selected for the different programs (e.g., content assets) in the content stream. Example content types may comprise sports, movies, news, documentary, a combination thereof, and/or the like.

According to the present methods and systems, an encoder configuration controller 202 may select a known encoding profile (e.g., encoding template) associated with the content type of particular content (e.g., content associated with a content asset). Encoding profiles (e.g., encoding templates) may be generated for different content types and/or other features associated with content (e.g., content associated with a content asset). For example, encoding profiles may be selected based on the source, content type, program associated with a content asset (e.g., content medium, content distribution, content channel, etc.), and/or any other attribute of the content. Once a program has ended, the encoder configuration controller 202 may receive the metadata for the next program and apply a new encoding profile to the encoder (e.g., based on content type, source, content asset, etc.). This process may continue for the life of the service (e.g., source of a content asset).

A program metadata server 204 may be configured to store content data, such as electronic program guide data, metadata, and/or the like. For example, the content data may comprise a schedule of programs (e.g., content items) for each of a plurality of content assets (e.g., linear content channels, content media, content distribution, content channel, online channel, show, media, etc.). One or more (or each) of the programs may be associated with a corresponding content type (e.g., genre), a keyword, a title, a resolution (e.g., standard definition, high definition, ultra high definition, high dynamic range), an actor, an episode number, a combination thereof, and/or the like.

The program metadata server 204 may transmit the content data to the encoder configuration controller 202. The encoder configuration controller 202 may select an encoding profile based on the content data. The encoder configuration controller 202 may determine a program (e.g., a program currently being received via the source or scheduled to be received, a program associated with a content asset, etc.) to be encoded (e.g., or currently being encoded) by an encoder 206. The encoder configuration controller 202 may determine the program based on a current time, a start time of the program, an end time of the program, and/or the like. The encoder configuration controller 202 may select an encoding profile based on the content data associated with the program. For example, a type of the program, a resolution, and/or the like may be associated with a particular encoding profile. As another example, the content data may be associated with specific encoder configuration settings that the encoder configuration controller 202 may use to generate an encoding profile for the current program.

Configuration parameters for encoding profiles may be selected based on a type (e.g., characteristic) of the content. For example, for high motion content (e.g., sports) an encoding profile may be selected with a higher bitrate, higher de-ringing filter, and/or higher de-blocking filter (e.g., since the content will more than likely be coming from a pre-compressed source). Additionally, an advanced rate distortion optimization (RDO) algorithm may be selected for high motion content. For news content, an encoding profile may be selected in which most filtering is turned off. A lower bitrate may be selected for news content (e.g., since the source of the content will originate near the encoder and have no pre-compression artifacts). Encoding profiles for news content might not include the advanced RDO algorithm. Exclusion of the advanced RDO algorithm may save on processing power while maintaining optimum video quality.

Configuration parameters may be adjusted (e.g., modified) for filters, processing algorithms, and/or the like. For example, a configuration parameter may comprise a parameter for a sharpening filter, a deblocking filter, a cross-talk filter, spatial denoising, a motion compensated temporal filter (MCTF), a temporal low pass, a horizontal luma filter, an anti-alias, a stress bias, adaptive pre-processing, a horizontal bandwidth, motion compensated temporal recursive filtering. The parameter may be a parameter to enable (e.g. use) or disable a filter. The parameter may be a level (e.g., high, medium, low, a numerical value on a scale) to apply a filter. The parameter may comprise one or more additional settings for a filter.

Additionally, the sharpening filter may be enabled where a content source changes from a documentary back to a news program where crawls (e.g., dot crawls, checkerboard patterns which appear along horizontal color transitions) are present. The sharpening filter may be configured to preserve/enhance edges around text. A deblocking filter may be enabled if/when a source is heavily compressed creating significant blockiness on the input to an encoder. Motion compensated temporal recursive filtering may be enabled if/when the source has random noise (e.g., caused by the way the program was captured on camera or due to the type and quality of cameras used). Spatial denoising may be enabled to remove random noise caused by film conversion or poor compression. The temporal low pass filter may be enabled to remove noise on input as complimentary to motion compensated temporal filtering (e.g., by leveraging look ahead statistics).

The encoder configuration controller 202 may send the selected encoding profile to the encoder 206 (e.g., transcoder). The encoder 206 may encode the corresponding program using encoder configuration settings specified in the selected encoding profile. The encoder 206 may transmit encoded content to one or more users for consumption.

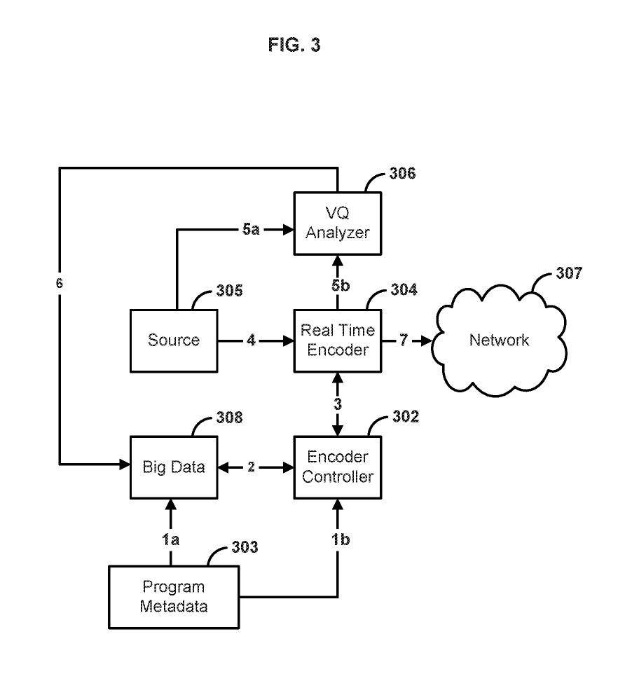

FIG. 3 is a diagram of example encoding for a content source. The present methods and systems improve upon a standard encoder by leveraging a video quality analyzer (e.g., external video quality analyzer), big data processing tools, content metadata (e.g., from an electronic program guide), and/or the like to determine and implement the best possible compression algorithms to ensure highest video quality possible. Conventional and big data storage technologies may be used to keep track of services (e.g., sources), metadata 303 associated with programs (1a) (e.g., obtained from an electronic program guide server), encoding quality metrics (e.g., for pre and post compressed video), baseline encoding profiles (e.g., baseline encoder settings), current audience metrics, adjusted encoder settings, a combination thereof, and/or other data.

An encoder controller 302 may determine and set encoder settings at the beginning of each program (3). The encoder controller 302 may modify the encoder settings appropriately based on a known good template for a specific service and type of program (1b). The encoder 304 may acquire (4) source video from a source 305 and produce encoded video for distribution (7) to a network 307. A video quality analyzer 306 may prepare video quality reports for the content produced by the real time encoder (5b), factoring in the quality of source video (5a) as a baseline.

Video quality reports may be sent to a big data processing system 308 for real time and historical analysis (6). Real time processing tools may be employed to analyze video quality reports, compare the video quality reports to baseline video quality measurements, and report deviations from the baseline video quality measurements to the encoder controller (2). The encoder controller 302 in response may make video quality adjustments to compensate for deviations reported by the big data system (3). Video quality adjustments may be transmitted back to the analytics system (2) so that the video quality adjustments may be assessed in real time against resultant live video quality data to gauge their effectiveness. This process may create a real time feedback loop which may potentially make video quality responsive within a program or piece of content. A history of modifications to the base template specific to the service/program may be stored. The history of modifications may be used When initiating future occurrences of the service/program. This process enables progressive improvement of video quality over time.

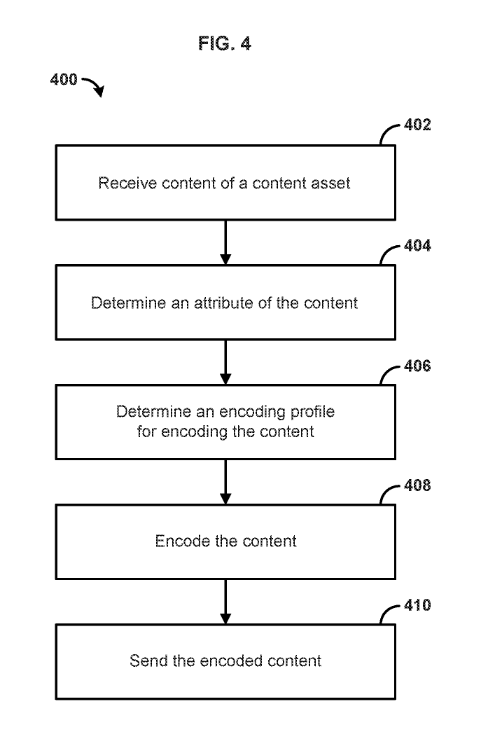

FIG. 4 is a flowchart of an example method 400 for encoding content.

At step 402, content of a content asset may be received. The content may be received by an encoder (e.g., transcoder) from a source e.g., of the content asset). The content asset may comprise a linear content channel. The encoder may be assigned, at least temporarily, to the source and/or content asset. The content may comprise a video transmission (e.g., video stream, video file transfer), an audio transmission (e.g., audio stream, audio file transfer), text (e.g., overlays, closed captions), a combination thereof, and/or the like. The source may be configured to transmit a sequence of programs (e.g., content items, shows, movies, newscasts) via a content asset (e.g., content media, content distribution, content channel, online channel, show, media etc.). Each of the programs of the sequence of programs may comprise a respective start time and an end time. The content may comprise a program of the sequence of programs.

At step 404, an attribute of the content may be determined. The attribute may comprise a type of the content, a program (e.g., program identifier) of the content, a source identifier (e.g., channel identifier), a resolution of the content, and/or the like. The attribute may be determined by the encoder. The attribute may be determined based on electronic program guide data (e.g., metadata associated with programs). The attribute may be determined by querying an electronic program guide (e.g., implemented at a remote device). For example, an identifier of the content (e.g., or content asset, or source) may be sent with a request for metadata associated with the content (e.g., content asset, or source). As another example, the encoder may request metadata associated with a current program or a next scheduled program for the source.

Determining the attribute (e.g., type) of the content may comprise determining a program in the content and determining the type of the content based on the program. For example, the program may be determined based on temporal data associated with the program such as the sequence of programs, the start times, the end times, and/or the like. The program may be a current program or a future program (e.g., a next program after the current program in the sequence of programs). The electronic program guide may respond to the request with the requested metadata (e.g., type of the content). The attribute may also be determined by analyzing the content and/or metadata received with the content (e.g., fields of a transport stream).

At step 406, an encoding profile for encoding the content may be determined (e.g., received, selected). The encoding profile may be received by the encoder from a remote device. The remote device may comprise an encoding controller, an encoding profile server, and/or the like. The encoding profile may be received in response to transmitting, by the encoder, the attribute (e.g., type) of the content to the remote device.

The encoding profile may comprise a plurality of encoding settings. For example, the encoding profile may comprise a bit rate setting, a resolution setting, or a combination thereof. The encoding profile may specify filtering (e.g., pre-processing filtering), a weight of the filtering (e.g., low, medium, high, which may be different for each filtering specified), a type of rate distortion optimization, GOP structure, audio transcode settings (e.g., format, and bitrate), and/or the like.

The encoding profile may be selected (e.g., by the remote device) based on the content asset e.g., content media, content distribution, content channel, online channel, show, media, etc.) and/or source. The encoding profile may be selected (e.g., by the remote device) based on the attribute. The remote server may store a plurality of encoding files. The remote device can store data associating encoding profiles with corresponding programs (e.g., programs associated with a content asset), content assets (e.g., content media, content distribution, content channel, online channel, show, media, etc.), sources (e.g., sources of content assets), encoders, types of content, and/or the like. The remote device may store historical information. The historical information may comprise a history of which of the plurality of encoding profiles have been used for which content assets (e.g., content media, content distribution, content channel, online channel, show, media, etc.), sources (e.g., sources of content assets), encoders, types of content, and/or the like. The historical information may comprise a history of encoding quality metrics indicating encoding quality resulting from corresponding encoding profiles.

The historical information may be analyzed to determine the encoding profile for the content. For example, a type of the content may be determined. The type may be matched to types of content associated with the historical information (e.g., for a specific channel and/or generally). The encoder configuration may have the best known configuration applied at the time the program begins.

At step 408, the content may be encoded based on the encoding profile. The encoder may encode the content (e.g., upon receiving the encoding profile). The encoder may be configured to encode the content in real-time as the content is received from the source via a content asset (e.g., content channel). If the encoding profile is associated with a particular program that has not yet begun, the encoder may use the encoding profile when (e.g., at a start time of the program) the program is received from the source.

At step 410, the encoded content may be transmitted/sent. Transmitting the encoded content may comprise transmitting the encoded content to an encoding quality analyzer configured to analyze encoding quality of the encoded content. The encoding quality analyzer may be located locally or remotely from the encoder. The encoding quality analyzer may transmit the encoding quality to the remote device. The encoded content may also be transmitted to one or more user devices (e.g., via a content distribution network and/or content access network). The encoded content may be transmitted via quadrature amplitude modulation (QAM) channel of a cable delivery network, a packet switched delivery network (e.g., internet protocol based network), a combination thereof, and/or the like.

The method 400 may further comprise modifying the encoding profile based on the encoding quality. The encoding profile may be modified by the encoder, the remote device, the encoding quality analyzer and/or by any other device. For example, the remote device may store encoding quality metrics associated with corresponding encoding profiles of the plurality of encoding profiles. For example, after an encoding profile is used to encode the content, the encoded content may be analyzed by the encoding quality analyzer to determine post-encoding quality metrics. The post-encoding quality metrics may be compared to one or more baseline encoding quality metrics. The remote device may store the difference between the post-encoding quality metrics and the baseline encoding quality metrics. The difference may comprise an encoding quality metric. The encoding profile used to encode the content may be modified based on the differences. For example, if the difference is above a threshold, then one or more configuration settings of the encoding profile may be determined and modified to optimize the quality of future encoding based on the profile. Subsequent encoding of content using the encoding profile may be analyzed to further refine the encoding profile. For example, prior changes to the encoding profile that resulted in worse quality than previously measured may be undone or further refined. Previously unmodified encoder configuration settings may be modified to further improve the encoding profile and corresponding encoded content quality.

If the characteristics of the content changed from previously aired similar content (e.g., prior episode of a show analysis of current video quality metrics and/or encoding profile (e.g., configuration parameters thereof) may be performed to update the encoding profile for improved video quality performance. These new metrics and encoding profile (e.g., configuration parameters) may be stored (e.g., to be used the next time the content (e.g., or episode of the content) appears on the specific channel).

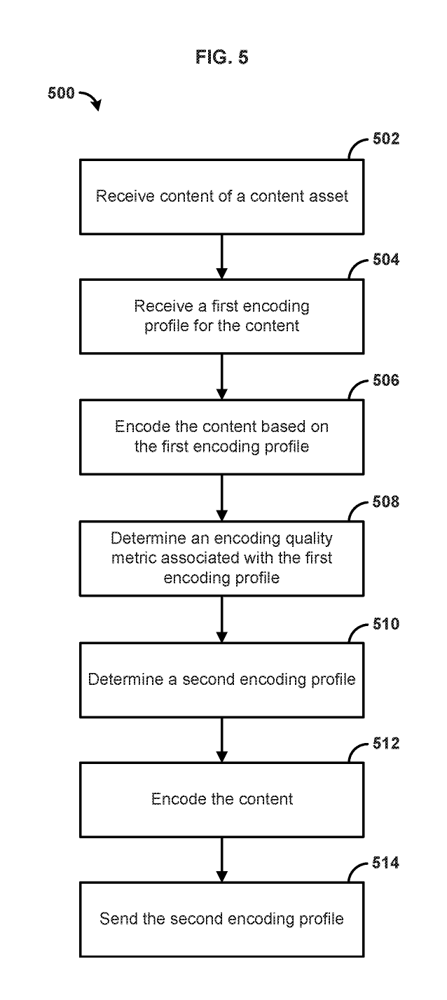

FIG. 5 is a flowchart of another example method 500 for encoding content. At step 502, content associated with a content asset may be received. The content may be received by an encoder from a source. The content asset can comprise a linear content channel. The encoder may be configured to encode the content in real-tune as the content associated with the content asset (e.g., source) is received. The encoder may be assigned, at least temporarily, to the content asset, the content, and combinations thereof. The content may comprise a video transmission (e.g., video stream, video file transfer), an audio transmission (e.g., audio stream, audio file transfer), text (e.g., overlays, closed captions), a combination thereof, and/or the like. The source may be configured to transmit a sequence of programs (e.g., movies, newscasts, etc.) via a content asset (e.g., content media, content distribution, content channel, online channel, show, media, etc.). Each of the programs of the sequence of programs may comprise a respective start time and an end time. The content may comprise a program of the sequence of programs.

The method 500 may comprise determining an attribute of the content. The attribute may comprise a type of the content associated with a content asset, a program (e.g., program identifier) of the content associated with the content asset, a source identifier (e.g., channel identifier), resolution of the content, and/or the like. The attribute may be determined by the encoder. The attribute may be determined based on electronic program guide data (e.g., metadata associated with programs). The attribute may be determined by querying an electronic program guide (e.g., implemented at a remote device). For example, an identifier of the content (e.g., content asset, source, etc.) may be sent with a request for metadata associated with the content (e.g., content asset, source, etc.). As another example, the encoder may request metadata associated with a current program associated with the content asset or a next scheduled program for the content asset (e.g., content media, content distribution, content channel, online channel, show, media, etc.

Determining the attribute (e.g., type) of the content may comprise determining a program associated with the content asset and determining the type of the content based on the program. For example, the program may be determined based on the sequence of programs, the start times, the end times, and/or the like. The program may be a current program or a future program (e.g., a next program after the current program in the sequence of programs). The electronic program guide may respond to the request with the requested metadata (e.g., type of the content). The attribute may also be determined by analyzing the content and/or metadata received with the content (e.g., fields of a transport stream).

The encoding profile may be selected (e.g., by the remote device) based on the attribute. The remote server may store a plurality of encoding files. The remote device may store data associating encoding profiles with corresponding programs, content assets (e.g., content media, content distributions, content channels, online channels, shows, media, etc.), encoders, types of content, and/or the like. The remote device may store a history of which of the plurality of encoding profiles have been used for which programs, content assets (e.g., content media, content distribution, content channel, online channel, show, media, etc.), encoders, types of content, and/or the like. The remote device may store encoding quality metrics indicating encoding quality resulting from corresponding encoding profiles.

At step 504, a first encoding profile for encoding the content may be received. The first encoding profile and the encoding quality metric may be received by the encoder from a remote device. The first encoding profile may comprise a bit rate setting, a resolution setting, or a combination thereof. The first encoding profile may specify filtering (e.g., pre-processing filtering), a weight of the filtering (e.g., low, medium, high, which may be different for each filtering specified), a type of rate distortion optimization, GOP structure, audio transcode settings (e.g., format, and bitrate), and/or the like.

At step 506, the content may be encoded based on the first encoding profile. The encoder may encode the content (e.g., upon receiving the encoding profile). The encoder may be configured to encode the content in real-time as the content is received from the source (e.g., via a content asset). If the first encoding profile is associated with a particular program that has not yet begun, the encoder may use the first encoding profile when (e.g., at a start time of the program) the program is received from the source.

At step 508, an encoding quality metric indicating encoding quality associated with the first encoding profile may be determined. The encoding quality metric may be determined based on analysis of the content (e.g., program) encoded by the first encoding profile. The encoding quality metric may be determined at the encoder by receiving the encoding quality metric from an encoding quality analyzer.

The encoding quality metric may be based on a quality of the content as received from the source. For example, the encoding quality metric may take into account a baseline quality associated with the content (e.g., the source, the program, the content asset).

At step 510, a second encoding profile may be determined (e.g., selected, generated) based on the encoding quality metric. The second encoding profile may be determined based on the first encoding profile. An encoder setting of the first encoding profile may be modified. For example, the encoding quality metric may be compared to a baseline quality metric. If the difference between the encoding quality metric and the baseline quality metric is above a threshold, then one or more configuration settings of the first encoding profile may be determined and modified to optimize the quality of future encoding based on the profile. The second encoding profile may be a modified copy of the first encoding profile. The second encoding profile may also be selected as a new profile to use.

For example, encoding quality metrics associated with corresponding encoding profiles of the plurality of encoding profiles may be stored (e.g., by the encoder, by the remote device). For example, after an encoding profile is used to encode the content, the encoded content may be analyzed by the encoding quality analyzer to determine post-encoding quality metrics. The post-encoding quality metrics may be compared to one or more baseline encoding quality metrics. The difference between the post-encoding quality metrics and the baseline encoding quality metrics may be stored. The difference may comprise an encoding quality metric. The first encoding profile used to encode the content may be modified based on the differences.

At step 512, the content may be encoded (e.g., by the encoder) based on the second encoding profile. The encoder may encode the content (e.g., upon receiving the second encoding profile). The encoder may be configured to encode the content in real-time as the content is received from the source. If the second encoding profile is associated with a particular program that has not yet begun, the encoder may use the second encoding profile when (e.g., at a start time of the program) the program is received from the source.

The encoding of content based on the second encoding profile may occur subsequently to the encoding of content based on the first encoding profile. The content encoded using the second encoding profile may be analyzed to further refine the second encoding profile. For example, differences between the first encoding profile and the second encoding profile that resulted in worse encoding quality may be undone or further refined. Previously unmodified encoder configuration settings may be modified to further improve the encoding profile and corresponding encoded content quality.

At step 514, the second encoding profile may be transmitted/sent (e.g., by the encoder) to the remote device. The second encoding profile may be stored at the remote device. The second encoding profile may be transmitted by remote device to another encoder for encoding the same or similar content (e.g., content of the same type, content of same series, content of the same resolution).

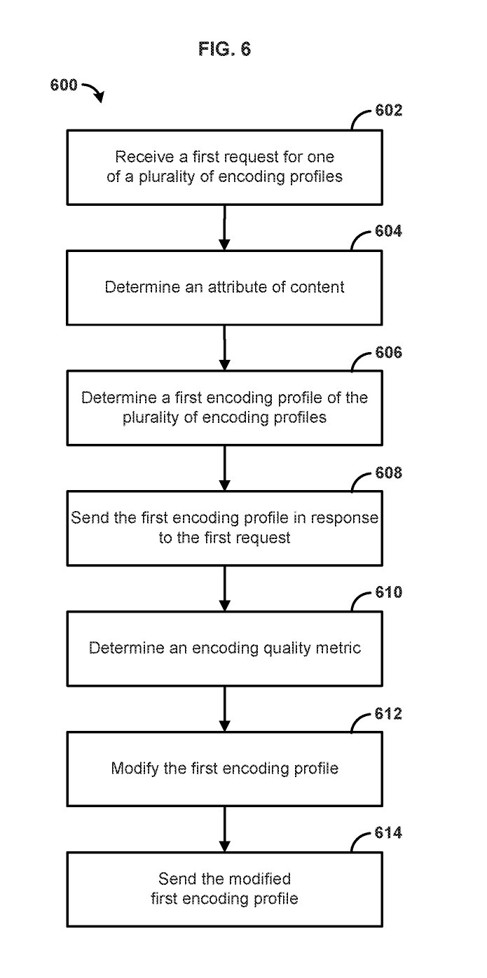

FIG. 6 is a flowchart of another example method 600 for encoding content. At step 602, a first request for one of a plurality of encoding profiles for encoding the content may be received. The first request may be received from a first encoder. The first request may be received by a first device, such as encoding controller, a remote encoding management device. The first device may be remote from the encoder. The first device may manage a plurality of encoders, such as the first encoder and a second encoder.

The first encoder may be configured to receive the content from a source of a content asset. The content asset may comprise a linear content channel. The first encoder may be assigned, at least temporarily, to the source and/or content asset. The content may comprise a video transmission (e.g., video stream, video file transfer), an audio transmission (e.g., audio stream, audio file transfer), text (e.g., overlays, closed captions), a combination thereof, and/or the like. The source may be configured to transmit a sequence of programs (e.g., movies, newscasts, etc.) via a content asset (e.g., content media, content distribution, content channel, online channel, show, media, etc.). Each of the programs of the sequence of programs may comprise a respective start time and an end time. The content may comprise a program of the sequence of programs.

At step 604, an attribute of the content may be determined (e.g., by the first device). The attribute may be determined by and received from the first encoder. For example, the attribute may be received with the first request. The attribute may comprise a type of the content, a program (e.g., program identifier) of the content, an identifier associated with the source (e.g., content asset identifier), a resolution of the content, and/or the like. The attribute may be determined based on electronic program guide data (e.g., metadata associated with programs). The attribute may be determined by querying an electronic program guide (e.g., implemented at a remote device, such as an encoding quality analyzer). For example, an identifier of the content (e.g., or source) may be sent with a request for metadata associated with the content (e.g., or source). As another example, metadata associated with a current program or a next scheduled program for the source (e.g., content asset) may be requested.

Determining the attribute (e.g., type) of the content may comprise determining a program in the content and determining the type of the content based on the program. For example, the program may be determined based on the sequence of programs, the start times, the end times, and/or the like. The program may be a current program or a future program (e.g., a next program after the current program in the sequence of programs). The electronic program guide may respond to the request with the requested metadata (e.g., type of the content). The attribute may also be determined by analyzing the content and/or metadata received with the content (e.g., fields of a transport stream).

At step 606, a first encoding profile of plurality of encoding profiles may be determined based on the attribute. Determining the first encoding profile of plurality of encoding profiles based on the attribute may comprise determining the first encoding profile based on a content asset associated with the content, a program of the content, or a combination thereof.

The first encoding profile may comprise a bit rate setting, a resolution setting, or a combination thereof. The first encoding profile may specify filtering (e.g., pre-processing filtering), a weight of the filtering (e.g., low, medium, high, which may be different for each filtering specified), a type of rate distortion optimization, GOP structure, audio transcode settings (e.g., format, and bitrate), and/or the like.

At step 608, the first encoding profile may be transmitted/sent to the first encoder in response to the first request. For example, the first device may transmit the first encoding profile to the first encoder. At step 610, an encoding quality metric indicating quality of encoding of the content by the first encoder may be determined. The encoding quality metric may be determined based on the first encoding profile.

At step 612, the first encoding profile may be modified based on the encoding quality metric. Modifying the first encoding profile based on the encoding quality metric may comprise modifying an encoding setting of the first encoding profile.

For example, the first device may store encoding quality metrics associated with corresponding encoding profiles of the plurality of encoding profiles. For example, after the first encoding profile is used to encode the content, the encoded content may be analyzed by the encoding quality analyzer to determine post-encoding quality metrics. The post-encoding quality metrics may be compared to one or more baseline encoding quality metrics. The first device may store the difference between the post-encoding quality metrics and the baseline encoding quality metrics. The difference may comprise an encoding quality metric. The first encoding profile used to encode the content may be modified based on the differences. For example, if the difference is above a threshold, then one or more configuration settings of the first encoding profile may be determined and modified to optimize the quality of future encoding. Subsequent encoding of content using the modified encoding profile may be analyzed to further refine the encoding profile. For example, prior changes to the first encoding profile that resulted in worse quality than previously measured may be undone or further refined. Previously unmodified encoder configuration settings may be modified to further improve the encoding profile and corresponding encoded content quality.

At step 614, the modified first encoding profile may be transmitted/sent (e.g., by the first device) in response to a second request for one of the plurality of encoding profiles. The second request may be received from the first encoder and/or the second encoder. The modified first encoding profile may be transmitted to the first encoder and/or second encoder. For example, the second request may be related to encoding the same or similar content as encoded using the first encoding profile. For example, the content encoded by the first encoding profile may comprise a first program. The second encoding profile may be for encoding the first program again. The second encoding profile may be selected for encoding a second program. The second program may be associated with the same or a similar attribute as the first program. For example, the second program may be of the same type of content as the first program. The second program may be received from the same or similar source (e.g., content asset) as the first program. The second program may have the same or similar resolution as the first program.

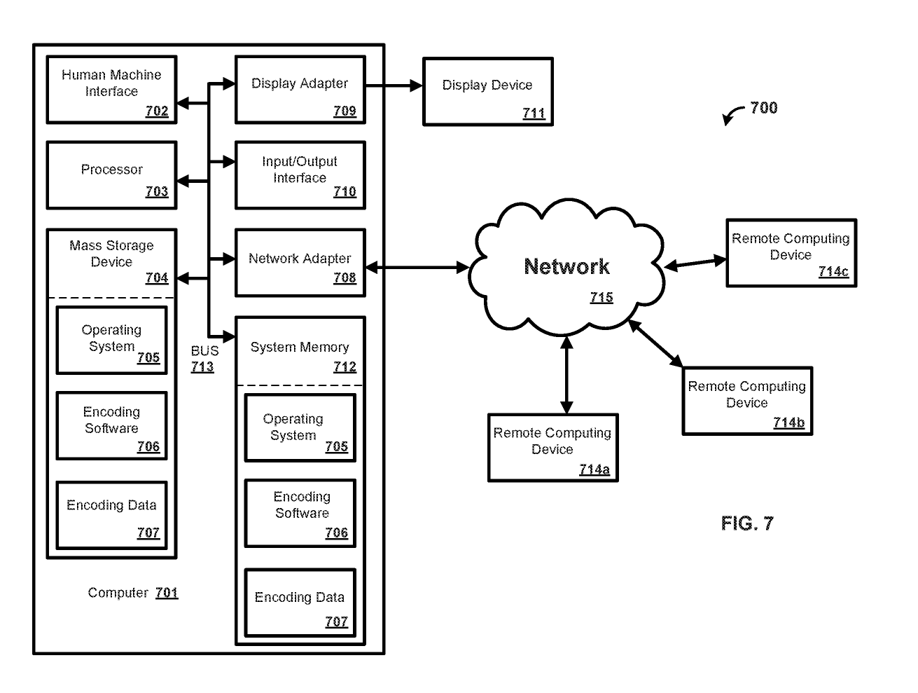

The methods and systems may be implemented on a computer 701 as exemplified in FIG. 7 and described below. By way of example, the encoder 112, the encoding manager 129, the EPG server 130, the quality analyzer 132 of FIG. 1 may each be a computer as exemplified in FIG. 7. Similarly, the methods and systems disclosed may utilize one or more computers to perform one or more functions in one or more locations. FIG. 7 is a block diagram of an example operating environment for performing the disclosed methods. This example operating environment is only an example of an operating environment and is not intended to suggest any limitation as to the scope of use or functionality of operating environment architecture. Neither should the operating environment be interpreted as having any dependency or requirement relating to any one or combination of components detailed in the example operating environment.

The present methods and systems may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems may be performed by software components. The disclosed systems and methods may be described in the general context of computer-executable instructions, such as program modules, being executed by one or more computers or other devices. Generally, program modules comprise computer code, routines. programs, objects, components, data structures, etc. that perform particular tasks or implement particular abstract data types. The disclosed methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods disclosed herein may be implemented via a general-purpose computing device in the form of a computer 701. The components of the computer 701 may comprise, but are not limited to, one or more processors 703, a system memory 712, and a system bus 713 that couples various system components including the one or more processors 703 to the system memory 712. The system may utilize parallel computing.

The system bus 713 represents one or more of several possible types of bus structures, including a memory bus or memory controller, a peripheral bus, an accelerated graphics port, or local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description may also be implemented over a wired or wireless network connection and each of the subsystems, including the one or more processors 703, a mass storage device 704, an operating system 705, encoding software 706, encoding data 707, a network adapter 708, the system memory 712, an Input/Output Interface 710, a display adapter 709, a display device 711, and a human machine interface 702, may be contained within one or more remote computing devices 714a,b,c, at physically separate locations, connected through buses of this form, in effect implementing a fully distributed system.

The computer 701 typically comprises a variety of computer readable media. Readable media may be any available media that is accessible by the computer 701 and comprises, for example and not meant to be limiting, both volatile and non-volatile media, removable and non-removable media. The system memory 712 comprises computer readable media in the form of volatile memory, such as random access memory (RAM), and/or non-volatile memory, such as read only memory (ROM). The system memory 712 typically comprises data such as the encoding data 707 and/or program modules such as the operating system 705 and the encoding software 706 that are immediately accessible to and/or are presently operated on by the one or more processors 703.

Additionally, the computer 701 may also comprise other removable/non-removable, volatile/non-volatile computer storage media. By way of example, FIG. 7 exemplifies the mass storage device 704 which may provide non-volatile storage of computer code, computer readable instructions, data structures, program modules, and other data for the computer 701. For example and not meant to be limiting, the mass storage device 704 may be a hard disk, a removable magnetic disk, a removable optical disk, magnetic cassettes or other magnetic storage devices, flash memory cards, CD-ROM, digital versatile disks (DVD) or other optical storage random access memories (RAM), read only memories (ROM), electrically erasable programmable read-only memory (EEPROM), and the like.

Optionally, any number of program modules may be stored on the mass storage device 704, including by way of example, the operating system 705 and the encoding software 706. Each of the operating system 705 and the encoding software 706 (or some combination thereof) may comprise elements of the programming and the encoding software 706. The encoding data 707 may also be stored on the mass storage device 704. The encoding data 707 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple systems.

The user may enter commands and information into the computer 701 via an input device (not shown). Examples of such input devices comprise, but are not limited to, a keyboard, pointing device (e.g., a “muse”), a microphone, a joystick, a scanner, tactile input devices such as gloves, and other body coverings, and the like These and other input devices may be connected to the one or more processors 703 via the human machine interface 702 that is coupled to the system bus 713, but may be connected by other interface and bus structures, such as a parallel port, game port, an IEEE 1394 Port (also known as a Firewire port), a serial port, or a universal serial bus (USB).

Additionally, the display device 711 may also be connected to the system bus 713 via an interface, such as the display adapter 709. It is contemplated that the computer 701 may have more than one display adapter 709 and the computer 701 may have more than one display device 711. For example, the display device 711 may be a monitor, an LCD (Liquid Crystal Display), or a projector. In addition to the display device 711, other output peripheral devices may comprise components such as speakers (not shown) and a printer (not shown) which may be connected to the computer 701 via the Input/Output Interface 710. Any step and/or result of the methods may be output in any form to an output device. Such output may be any form of visual representation, including, but not limited to, textual, graphical, animation, audio, tactile, and the like. The display device 711 and computer 701 may be part of one device, or separate devices.

The computer 701 may operate in a networked environment using logical connections to one or more remote computing devices 714a,b,c. By way of example, a remote computing device may be a personal computer, portable computer, smartphone, a server, a router, a network computer, a peer device or other common network node, and so on. Logical connections between the computer 701 and a remote computing device 714a,b,c may be made via a network 715, such as a local area network (LAN) and/or a general wide area network (WAN). Such network connections may be through the network adapter 708. The network adapter 708 may be implemented in both wired and wireless environments. Such networking environments are conventional and commonplace in dwellings, offices, enterprise-wide computer networks, intranets, and the Internet.

For purposes of example, application programs and other executable program components such as the operating system 705 are shown herein as discrete blocks, although it is recognized that such programs and components reside at various times in different storage components of the computing device 701, and are executed by the one or more processors 703 of the computer. An implementation of the encoding software 706 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. For example, computer storage media may comprise, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The methods and systems may employ Artificial Intelligence techniques such as machine learning and iterative learning. Examples of such techniques include, but are not limited to, expert systems, case based reasoning, Bayesian networks, behavior based AI, neural networks, fuzzy, systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be demonstrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as aspects of the present disclosure, with a true scope and spirit being indicated by the following claims.

What is claimed is:

1. A method comprising:
receiving, by an encoder from a content source, content associated with a content asset;
determining a type of the content;
sending, by the encoder, the type of the content to a remote device;
responsive to sending the type of the content, receiving, by the encoder from the remote device, an encoding profile for encoding the content,
wherein the encoding profile is associated with the content asset;
encoding, based on the encoding profile, the content; and
sending the encoded content.

2. The method of claim 1, wherein determining the type of the content comprises analyzing metadata associated with one or more programs associated with the content asset.

3. The method of claim 1, wherein sending the encoded content comprises sending the encoded content to an encoding quality analyzer.

4. The method of claim 3, further comprising:
determining, via the encoding quality analyzer, an encoding quality metric associated with the content; and
sending the encoding quality metric to the remote device.

5. The method of claim 4, further comprising:
modifying the encoding profile based on the encoding quality metric;
responsive to modifying the encoding profile, sending the encoding profile to the remote device;
encoding, based on the encoding profile, the content; and
sending the content to one or more user devices.

6. The method of claim 5, wherein the encoding profile comprises a bit rate setting, a resolution setting, or a combination thereof.

7. The method of claim 1, wherein the content asset comprises a linear content channel, and wherein the encoder is configured to encode the content in real-time as the content is received via the content source.

8. A method comprising:
receiving, by an encoder from a content source, content of a content asset;
receiving, by the encoder from a remote device, a first encoding profile for encoding the content;
encoding, based on the first encoding profile, the content;
determining an encoding quality metric associated with the first encoding profile;
determining, based on the encoding quality metric, a second encoding profile;
encoding, based on the second encoding profile, the content; and
sending, to the remote device, the second encoding profile.

9. The method of claim 8, further comprising determining, based on metadata, a type of the content, wherein the first encoding profile is selected, by the remote device, for the encoder to encode the content based on the type of the content.

10. The method of claim 8, wherein determining the second encoding profile comprises modifying, based on the encoding quality metric, an encoder setting of the first encoding profile, wherein the encoder setting of the first encoding profile corresponds to a modified encoder setting of the second encoding profile.

11. The method of claim 8, wherein the encoding quality metric is based on a quality of the content as received from the content source.

12. The method of claim 8, wherein the content comprises a program, and wherein the encoding quality metric is determined based on analysis of the program encoded by the first encoding profile.

13. The method of claim 8, wherein the first encoding profile comprises a bit rate setting, a resolution setting, and combinations thereof.

14. The method of claim 8, wherein the content asset comprises a linear content channel, and wherein the encoder is configured to encode the content in real-time as the content is received from the content source.

15. The method of claim 8, further comprising sending the content to one or more user devices.

16. A method comprising:
receiving, by a network device, from a first encoder, a first request for one of a plurality of encoding profiles for encoding the content;
determining an attribute of the content;
determining, based on the attribute, a first encoding profile of plurality of encoding profiles;
sending, to the first encoder and in response to the first request, the first encoding profile;
determining, based on the first encoding profile, an encoding quality metric indicating quality of encoding of the content by the first encoder;
modifying, based on the encoding quality metric, the first encoding profile; and
sending, in response to a second request for one of the plurality of encoding profiles, the modified first encoding profile.

17. The method of claim 16, wherein the attribute comprises a type of the content.

18. The method of claim 17, wherein determining, based on the attribute, the first encoding profile of plurality of encoding profiles comprises determining the first encoding profile channel based on a content of the content, a program of the content, and combinations thereof.

19. The method of claim 16, wherein modifying, based on the encoding quality metric, the first encoding profile comprises modifying an encoding setting of the first encoding profile, wherein the encoder setting of the first encoding profile corresponds to a modified encoder setting of the second encoding profile.

20. The method of claim 16, further comprising, sending, by the network device, the modified first encoding profile to a second encoder.
